(19) United States
(12) Patent Application Publication
(10) Pub. No.: US 2016/0097520 A1
(43) Pub. Date: Apr. 7, 2016

(54) Permanently Installed Hide-Away Christmas Light Panel

(71) Applicant: Brian Michael Dunnihoo, Deming, NM (US)

(72) Inventor: Brian Michael Dunnihoo, Deming, NM (US)

(21) Appl. No.: 14/506,636

(22) Filed: Oct. 4, 2014

(51) Int. Cl. F21V 21/30; F21V 19/00; F21K 99/00

(52) U.S. Cl. CPC F21V 21/30; F21K 9/00; F21V 19/0015; F21Y 2105/001

(57) ABSTRACT

The “Permanently Installed Hide-Away Christmas Light Panels” provide a platform to house a variety of LED light displays in a rigid framework that can be permanently installed on the outside of any house or building that has a roof overhang and recessed soffit face. The panels are constructed using a mold injection process. The panel is constructed in two parts: a bottom plate that forms the shell of the panel and houses the channels, wells and framework tor the panel, and a flat top plate that completes the enclosure of the panel. Preexisting light strings can be snapped into the bottom plate assembly and covered with the top plate to create the finished panel. Terminal connections between two or more LED light strings are made on the outside of the two adjacent panels. The panel provides a system that holds the lights in fixed position for display and a rigid framework to pivot the lights as a unit to a position substantially hidden from view and exposure from the damaging effects of wind, rain and UV sun rays. No other system currently exists to house arrays of LED lights for the purpose of creating a whole-house ornamental lighting display. The panels are designed to accept preexisting LED lights in a variety of sizes and configurations. They are ideal for housing traditional “icicle” style LED light strings but can also accommodate LED light bars or LED Light strips. This panel light assemblies form the ideal rigid plastic platform to house UL approved LED “plug and play” lighting display systems. These festive lighting display panels can be thought of as analogous to the invention of the clear plastic waterproof housing that enables disposable cameras to be taken underwater. Similar to that concept, this invention takes a preexisting electrical product, engineered to code and UL safety standards, and houses them in a rigid plastic panel that enhances its usefulness and functionality. By incorporating commercially available LED lights designed for outdoor use, this plastic panel housing adds additional protection to these lights and makes it possible to permanently mount them on the outside of the house.

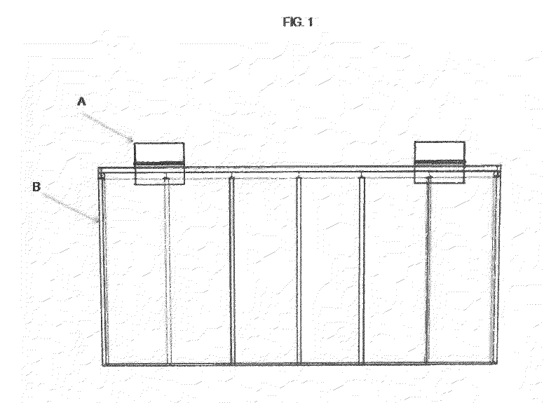

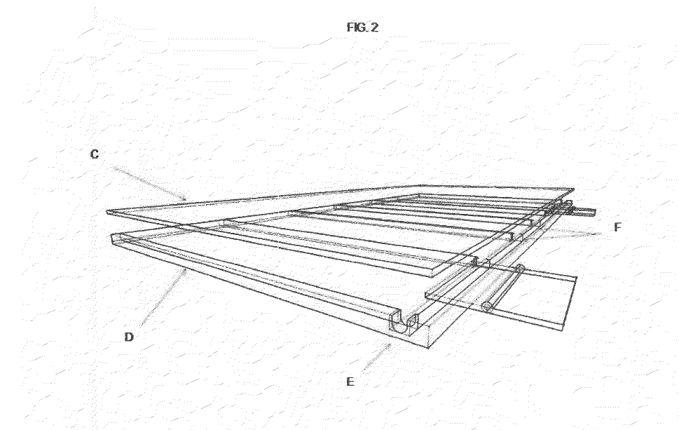

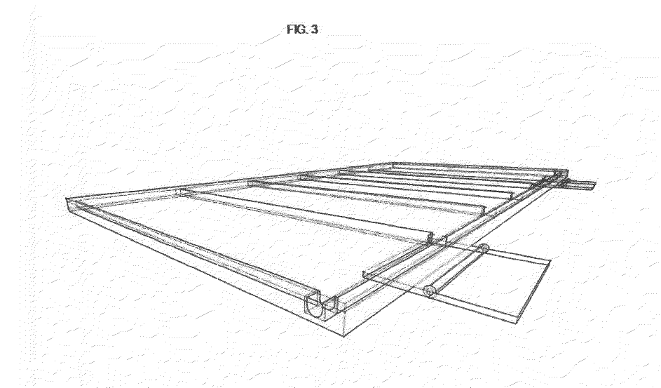

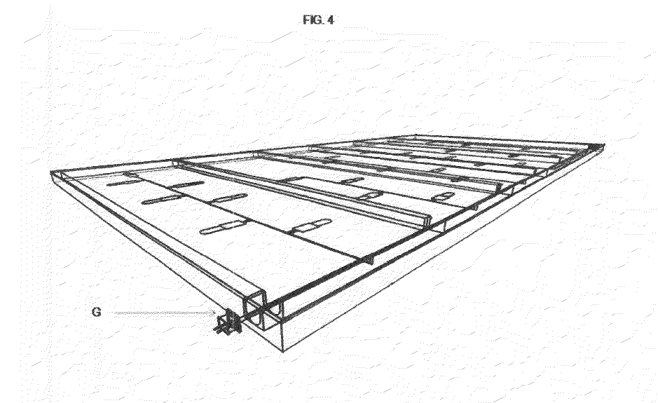

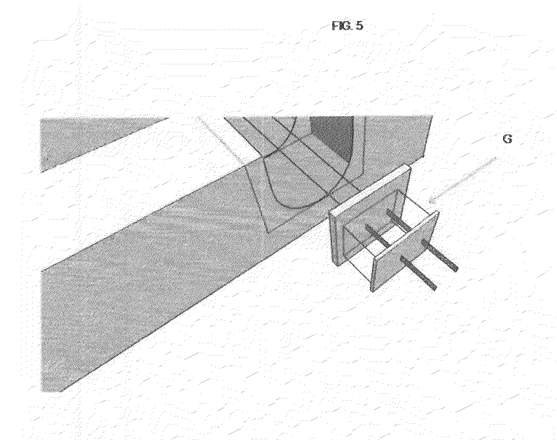

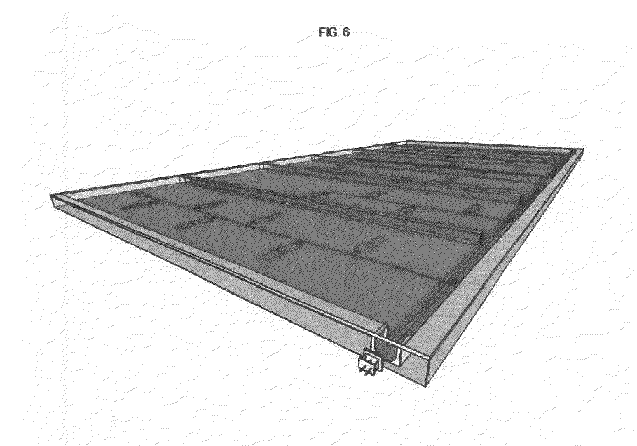

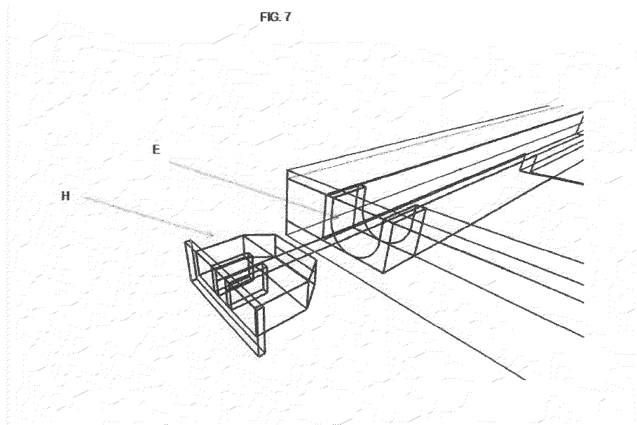

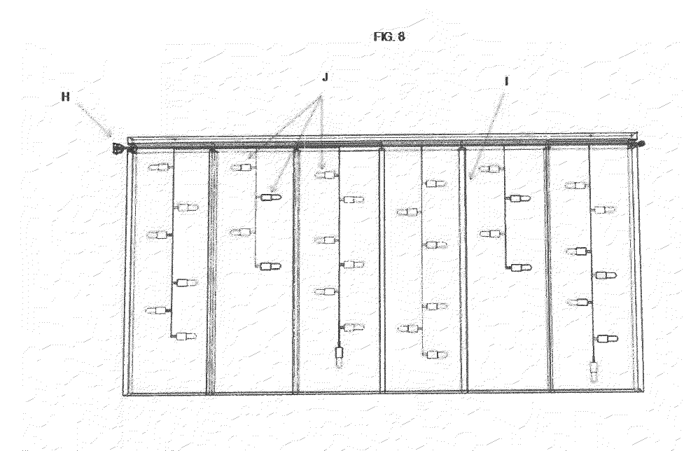

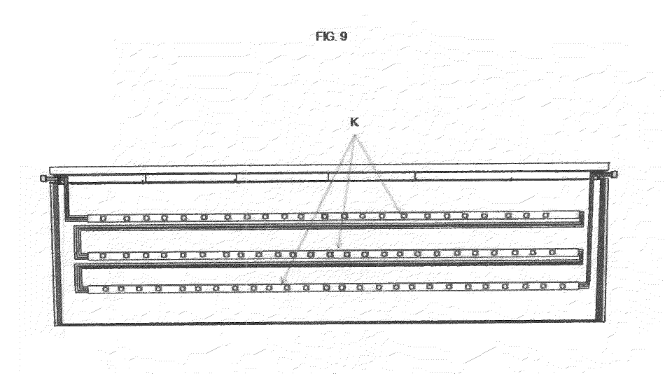

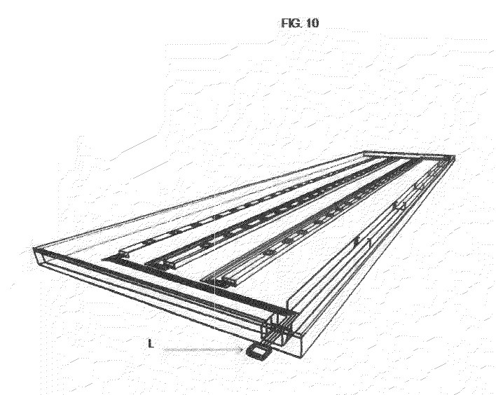

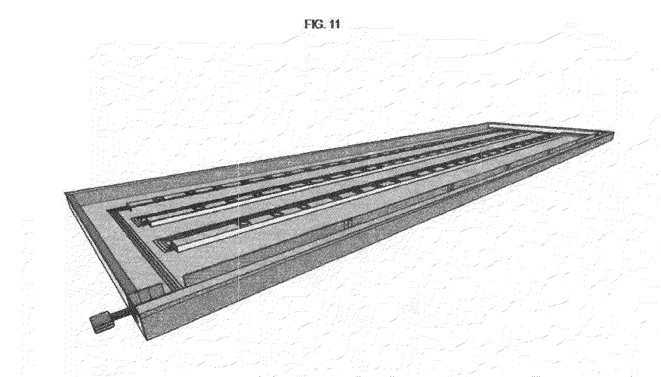

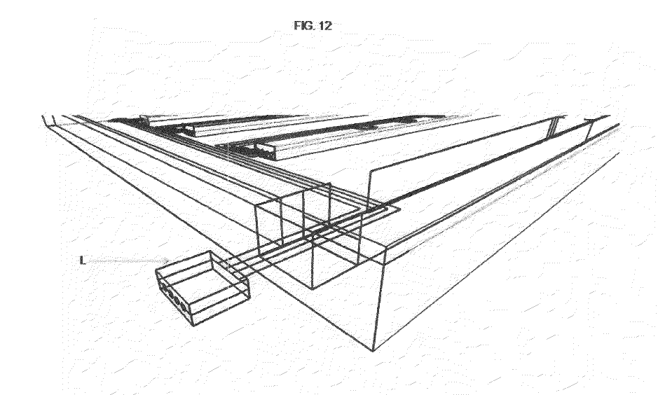

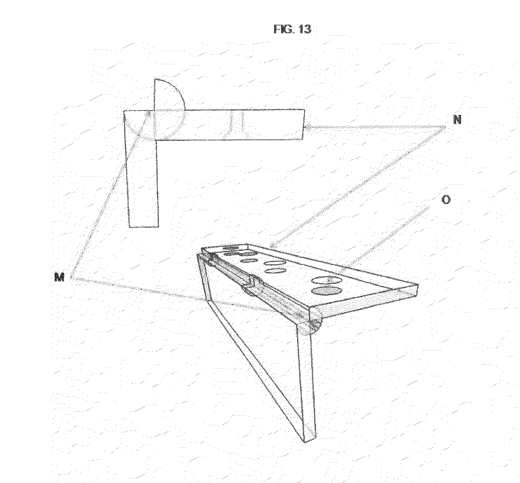

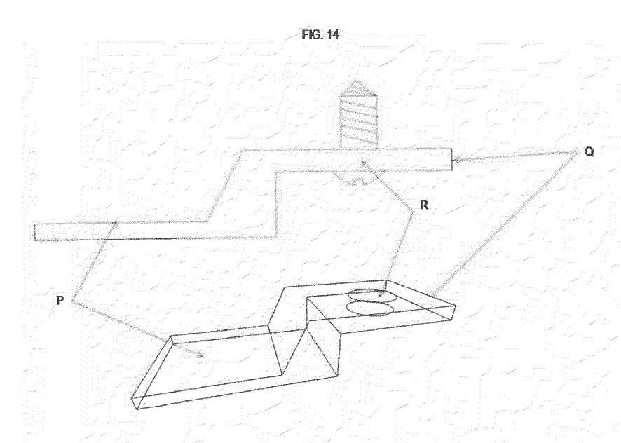

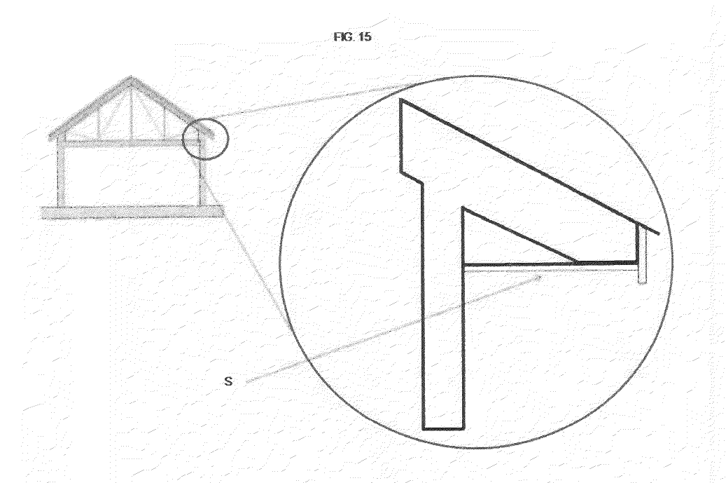

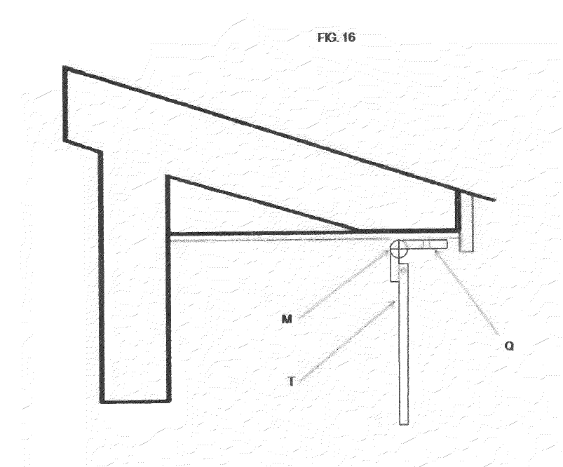

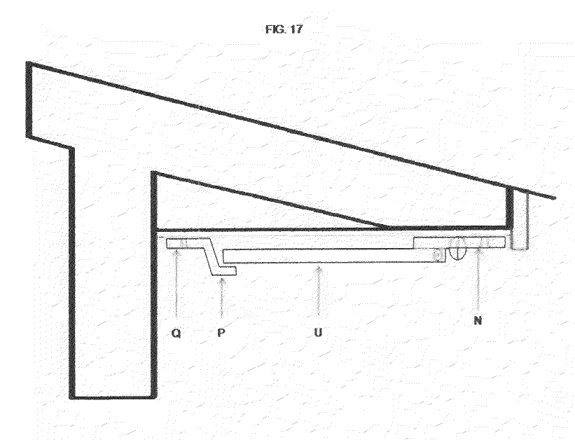

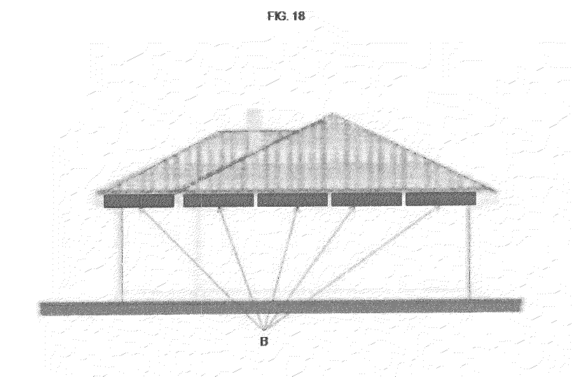

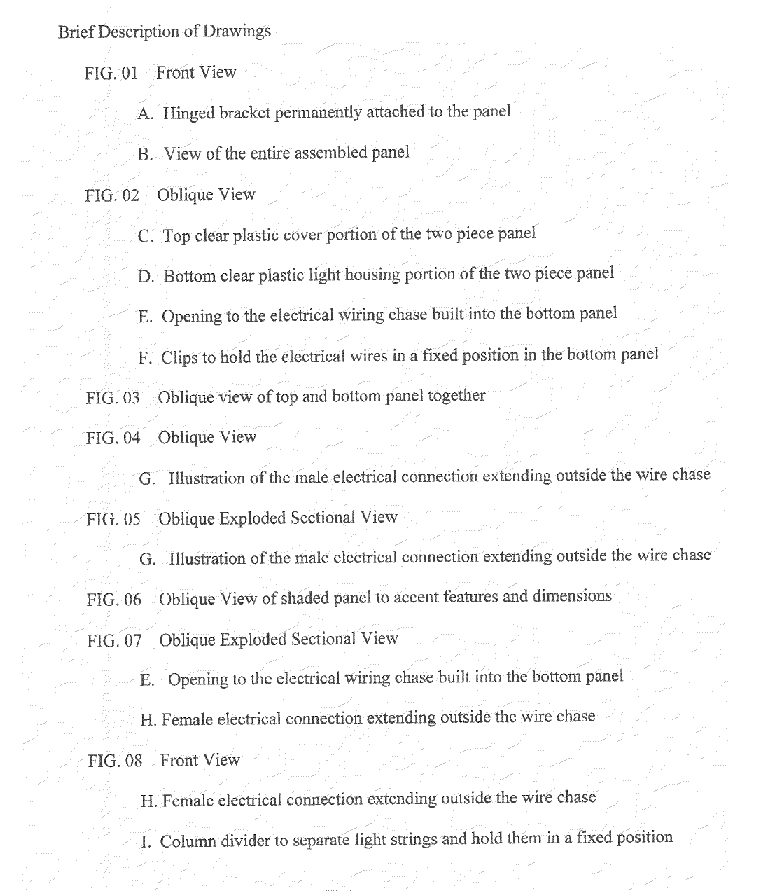

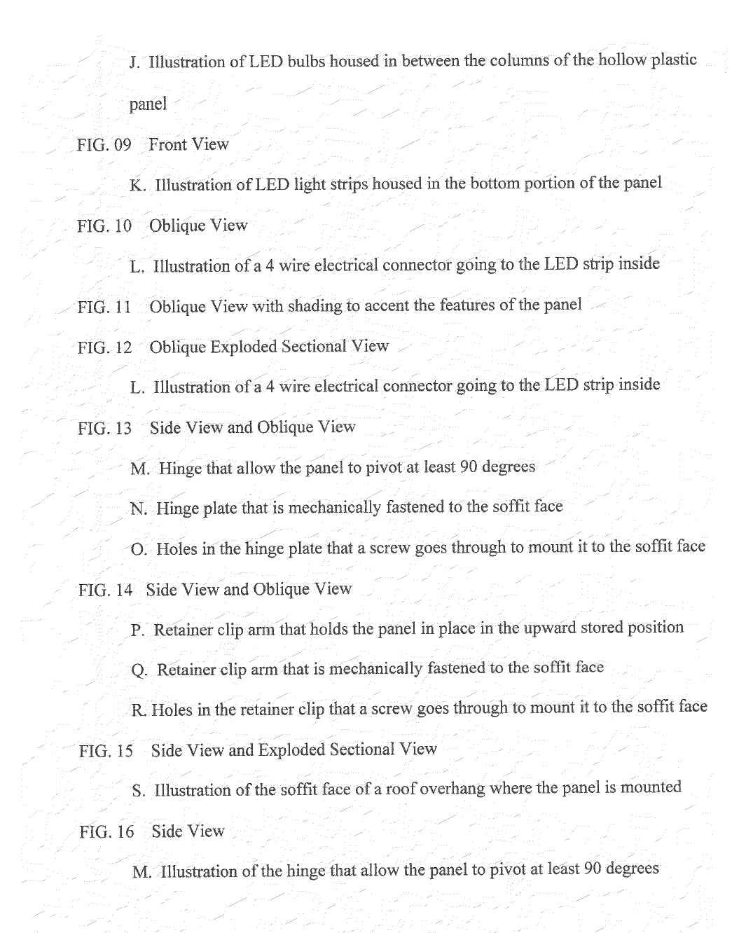

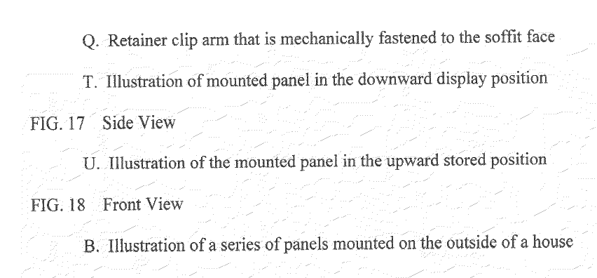

### TECHNICAL FIELD OF INVENTION

This invention relates to the general field of ornamental holiday lighting displays and more specifically to house-mounted LED Christmas lights.

### CLASSIFICATIONS

Illuminated Display Device: 40/544, 124.02,593; 362/503, 368, 397 40/594, 1274; 41/51/1111; LED Displays: 362/612; 362/23.16; 362/231; 362/245; 362/249.05; 362/249.06; 362/249.12, 362/800; 362/812; AC LED Strings: 315/185.00S, 315/185.00R; LED Strip Lighting: 362/217.17, 362/237, 362/249.01,439/210, 362/249.02; Bridge rectifier and fuse: 315/200.00R, 315/185.00S, 315/312, 315/209.00R, 315/205; Waterproof sockets: 439/620.31,439/620.32

### PATENT CITATIONS

U.S. Pat. No. 7,065,910, U.S. Pat. No. 6,190,207, U.S. 20040046510, U.S. Pat. No. 8,714,772, U.S. Pat. No. 7,802,903, U.S. Pat. No. 7,609,006, U.S. 20040046510

### BACKGROUND ART

Illuminated Display Device, Lighted display panels, LED string lights, and LED strip lights.

### SUMMARY OF THE INVENTION

An ornamental lighting display panel system consisting of clear plastic panels designed to house traditional light emitting diode (LED) Christmas lights in a rigid platform so they can be permanently installed on the outside of a house and move as a unit to a position underneath the overhang of the roof on the soffit face by virtue of an integrated hinged mounting bracket that allows the panels to pivot at least ninety degrees and a retaining clip that holds the panels in a substantially non-visible position.

### TECHNICAL PROBLEM

### Technical Problem:

Traditional ornamental “Christmas” string lights installed on the outside of a house deteriorate over time when exposed to the effects of wind, rain and the ultraviolet rays of the sun. Traditionally home owners will decorate their house with Christmas lights before the holidays and take them down afterwards. The process takes a great deal of effort and is very time consuming which explains why many people do not decorate their homes with Christmas lights.

### Technical Solution:

This invention solves this problem by providing a platform which allows traditional low voltage LED Christmas lights to be installed once and remain on the house permanently. The panels can be placed m a downward visible position and displayed like traditional Christmas lights during the holiday season, or placed in an upward “non-visible” position after the holidays. The process to display or hide these panels takes very little time or physical effort. This Christmas light display panel system provides a unique platform to enhance the functionality and useful life of traditional LED Christmas lights. By way of analogy, consider the invention of the clear plastic waterproof camera shell. That product didn't change the basic functionality of the camera itself but did expand its utility by creating a method for it to be used underwater. By extension it provided additional protection for the camera with its hard outer shell. That is the spirit of this invention. It seeks to take existing proven technology and house it in a platform that enhances its form and functionality. Permanently installed hide-away Christmas light panels are exactly what the name suggests. Clear plastic panels constructed in standard sizes and dimensions to house traditional “LED Christmas light” strings and emerging LED Christmas light strips in a rigid platform that allows them to be “permanently installed” on the outside of a house and have the appearance of traditional house-mounted Christmas lights; or “hidden away” out of sight underneath the overhang of the roof against the soffit face behind the fascia trim when not in use. They are installed once, displayed during the holidays, and stored in place when not in use. Because the panels are mounted to the house with a hinged bracket they can be pivoted to a position where a retainer clip catches the panel, and holds it in place out of the elements and substantially hidden from view. While Christmas lights have been around for many years, the concept of placing them in a rigid plastic panel, and permanently mounting them to a house in a manner that allows them to be hidden from view and exposure to the elements, has never been conceived of discussed in publication or brought to market in any form. Even though, LED light panels have been around for many years, their use as a “whole-house ornamental Christmas light display platform” is so far removed from their form or function as to have no relationship whatsoever to this invention. Additionally, unlike other lighted panels, this invention incorporates hinged mounting brackets and “locking” retainer clips that are essential components to the functionality of this invention. They allow the panels to be (1) permanently mourned to the house, (2) pivot at least ninety degrees to a position substantially hidden from, view, and (3) held in place away from exposure to the elements.

### ADVANTAGEOUS EFFECTS OF INVENTION

a. Eliminates the annual effort associated with decorating the trim of a house with LED Christmas lights, alter the initial installation.
b. Increases the useful life of the LED lights by housing them in a protective plastic panel and mounting them on the underside of the roof overhang.
c. Eliminates the damage caused to traditional light strings from handling them during the installation removal and storage process.
d. Eliminates the cost associated with paying someone to install Christmas lights on your house or business every year.
e. Increases the probability that more people will celebrate the holiday season with house-mounted Christmas lights because of the minimal effort necessary to deploy them.
f. Enhances the esthetics of the house. Because LED lights produce very little heat, the panels can be illuminated in the upward stored position providing accent lighting to the trim of the house.

### BRIEF DESCRIPTION OF DRAWINGS

Included in the PDF file containing the drawings

### DESCRIPTION OF EMBODIMENTS

### Example 1

LED “Icicle” Strings. In this embodiment the panels are designed to house traditional T 1 ¾ (0.5w) LED “icicle” string lights. The panel is constructed of clear plastic in two sections that am assembled to form, the complete panel. The bottom panel constitutes approximately three-fourths (¾^{th}) of the overall thickness of the felly assembled panel. The bottom panel houses two distinct areas: (1) the wire chase or channel running parallel to the length of the panel along the top portion, and (2) the area housing the lights which makes up the majority of the lower portion of the panel. In the wire chase portion of the panel there are plastic protrusions molded into the panel to act as wire “clips” to hold the electrical wires in a relatively fixed position. In the light display section of the panel there are plastic channels molded into the body of the panel approximately every four inches to separate the “strings” of the hanging icicle-style lights so they do not get tangled inside the panel. This embodiment is constructed in two sections so preexisting light strings can be placed inside the panel. In this embodiment the panels are twelve inches (12″) in height to accommodate the hanging length of most commercially available “icicle” LED Christmas light strings. Both the top and bottom panel sections are constructed using a mold injection process and are entirely made of a clear plastic material.

### Example 2

LED Light Strips. In this embodiment the panels axe designed to house waterproof LED light strips. The panel is constructed of clear plastic in two sections that are assembled to form the complete panel. The bottom panel constitutes approximately three-fourths (¾^{th}) of the overall thickness of the fully assembled panel. The bottom panel houses two distinct areas: (1) the wire chase or channel running parallel to the length of the panel along the top portion, and (2) the area housing the lights which makes up the majority of the lower portion of the panel. In the wire chase portion of the panel there axe plastic protrusions molded into the panel to act as wire “clips” to hold the electrical wires in a relatively fixed position. In the light display section of the panel the area is not defined with molded channels hut instead is an open space. This allows a variety of LED light strings to he positioned inside this display area. The panel is designed to house waterproof LED light strings or waterproof LED light bars. The LED light strings are adhered to the base of the panel with self adhesive backings on the printed circuit board that houses the surface mounted lights and electrical connections. In this embodiment the panel is only six inches in height. Because the light display area is an open space the LED light strings can be arranged in a variety of patterns. Our drawings show them laid out in rows running parallel to the length of the panel. Both the top and bottom panels sections are constructed using a mold injection process and axe entirely made of a clear plastic material.

### INDUSTRIAL APPLICABILITY

Industrial Applicability: Not Applicable

### REFERENCE SIGNS LIST

Not Applicable

### REFERENCE TO DEPOSITED BIOLOGICAL MATERIAL

Not Applicable

### SEQUENCE LISTING FREE TEXT

Not Applicable

### PATENT LITERATURE

Not Applicable

### NON PATENT LITERATURE

Not Applicable

### CLAIMS

See Attached PDF File

### DRAWINGS

See Attached PDF file

### SEQUENCE LISTING

Not Applicable

Independent claims for United States Patent protection:

1. An outdoor ornamental lighting display system consisting of: (1) a series of lightweight clear plastic rectangular panels designed to house light emitting diode (LED) lights; (2) two or more lightweight hinged brackets attached to each panel and capable of being mounted to a fiat surface and allowing the panels to pivot at least ninety degrees; and (3) two or more retainer clips associated with each panel mounted to flat surface and designed to hold the panels in one fixed position or release them to pivot to another position.

2. A clear plastic panel built in standard sizes and dimensions and having a two defined spaces: (1) an area dedicated to house an electrical wiring harness entering the panel on one side and leaving the panel on the other side, (2) an area dedicated to housing LED lights associated with the lighted display panel Both areas have channels or clips designed to hold the wires or lights in fixed positions.

3. A clear panel designed to house LED lights and associated electronics in a rigid plastic platform specifically intended to be mounted permanently on the outside of a house under the roof overhang with similar panels to create a whole house ornamental lighting display.
Dependent Claims (Elaborating on 3 Independent Claims)
a. Display “System”. This invention incorporates three parts that work to together make it possible to permanently mount, display and store Christmas lights on a house.
b. Clear Lightweight Rigid Plastic. The panels are constructed of a clear lightweight plastic or silicone resin that allows the encased LED lights to be visible and provides a rigid platform that allows them to move unit between their display and stored positions.
c. Encased LED Lights. The panels are designed to incorporate commercially available LED light strings or strips to replicate traditional house-mounted Christmas light displays and provide enhanced lighting display capabilities.
d. Sizes and Dimensions. The panels are rectangular in shape and constructed in. six and twelve inch heights to accommodate houses having different roof soffit dimensions. The panels are constructed in standard lengths (one, two, four and eight, feet) to accommodate houses having different roof dimensions. The panels have a thickness between three-eighth of an inch and three-quarter of an inch to house LED lights of different dimensions.
e. Hinged Mounting Brackets and Retainer Clips. The panels have a hinged, mounting bracket that is permanently attached to the panel and attached to the soffit face with screws. The hinge allows the panel to pivot at least ninety (90) degrees between a downward display positions to an upward stored position. The panel has a retainer clip which is attached to the soffit face with screws and designed to hold the panel in the upward position or release it to pivot to the downward display position.
